(19) United States
(12) Patent Application Publication
(10) Pub. No.: US 2020/0225449 A1
(43) Pub. Date: Jul. 16, 2020

(54) PHOTOGRAPHIC OBJECTIVE HAVING AT LEAST SIX LENSES

(71) Applicant: Leica Camera AG, Wetzlar (DE)

(72) Inventors: Achim Zirkel, Munich (DE); Marcus Deschauer, Munich (DE); Jakob Bleicher, Munich (DE)

(21) Appl. No.: 16/741,464

(22) Filed: Jan. 13, 2020

(30) Foreign Application Priority Data
Jan. 15, 2019 (DE) 102019100944.8

(51) Int. Cl. G02B 13/00; G02B 9/64

(52) U.S. Cl. CPC G02B 13/0045; G02B 9/64

(57) ABSTRACT

The present invention relates to a photographic objective having at least six lenses and at most eight lenses, with the first lens viewed from the object side being manufactured from glass and having a positive refractive power, an Abbe number of greater than or equal to 55, and a deviation of the relative partial dispersion from the normal line ΔP_{g,F} between 0.008 and 0.035.

The present invention relates to a photographic objective, in particular to a wide-angle objective, having at least six lenses and at most eight lenses, wherein the first lens viewed from the object side has a positive refractive power.

Technical developments have had the result that mobile devices such as cellphones, in particular so-called smartphones, or portable computers, in particular so-called tablet computers, are typically equipped with a camera or even with a plurality of cameras. The increasing miniaturization also requires objectives having a compact design. At the same time, a high lens speed is desired to also be able to take images having as little noise as possible under poor light conditions. Finally, high demands are also made on the image resolution.

Objective designs having six or seven lenses are described, for example, in the documents U.S. Pat. Nos. 9,366,845 B2, 8,854,744 B2, 8,717,685 B2 and 8,599,495 B1, with the majority of the lenses comprising plastic. Only the respective first lens is designed as a glass lens having a relatively small Abbe number. A four-lens objective having a first lens composed of glass and an Abbe number of 68 is described in document US 2004/0228009 A1. A large number of these objectives have a lens speed of approximately 1:2.3 or even of only 1:2.6 to 1:2.8.

The objectives described in this prior art only satisfy the above-named demands in part or not at all.

It is the object of the present invention to provide an objective that has a high lens speed, a compact design, and high optical resolution.

The object is achieved by an objective having the features of the independent claim. The objective in accordance with the invention comprises at least six lenses, with the first lens viewed from the object side being manufactured from glass and having a positive refractive power, an Abbe number of more than or equal to 55 and a deviation of the partial dispersion from the normal line ΔP_{g,F} between 0.008 and 0.035. The objective in accordance with the invention is in particular configured as a wide-angle objective. The order of the lenses or the position of a respective lens within the objective results from the numbering of the lenses, with the numbering taking place in ascending form from an end of the objective at the object side to an end of the objective at the image side.

In accordance with the invention, a special material is used for the first lens that has a relatively high Abbe number and an anomalous partial dispersion. The relative partial dispersion P_{g,F} is defined by:

$${P}_{g F} = \frac{{n}_{g} - {n}_{F}}{{n}_{F} - {n}_{C}} ,$$

where n_{F} is the refractive index at the Fraunhofer line F (wavelength 468.13 nm), n_{g} is the refractive index at the Fraunhofer line g (wavelength 435.83 nm), and n_{C} is the refractive index at the Fraunhofer line C (wavelength 656.28 nm).

The deviation of the relative partial dispersion ΔP_{g,F} from the normal line is defined by:

ΔP_{g,F}=P_{g,F}−(0.6438−0.001682·ν_{d}),

where v_{d} is the Abbe number at the Fraunhofer line d (wavelength 587.56 nm).

Exemplary commercially available glass types that satisfy said conditions are S-FPM3 and S-FPM2 from Ohara, MP-FCD1-M20, MP-FCD500-20, MP-PCD4-40, and MP-PCD51-70 from Hoya, Q-FKO1s from Hikari, and N-PK51, N-PSK52, and N-FK51a from Schott.

Common lens designs mostly use materials, in particular glass materials, in which the relative partial dispersion P_{g,F} is on or close to the normal line.

The longitudinal chromatic aberration can already be corrected so much by means of a first lens by the solution in accordance with the invention of manufacturing the first lens from a special glass that has a relatively high Abbe number and whose relative partial dispersion has a considerable deviation from the normal line that the other lenses can in large part be used for the correction of other aberrations. Chromatic aberrations as well as further aberrations can be corrected particularly easily and a very compact design can simultaneously be achieved in comparison with conventional designs for cellular radio applications that as a rule only use plastic lenses and are therefore subject to greater difficulties in chromatic aberration correction.

In accordance with a preferred embodiment, the objective comprises at least seven lenses, preferably exactly seven lenses. It has been found that a good compromise between compactness and optimized aberration correction can be achieved with six to eight lenses. More lenses can, however, also be provided, with further lenses being able to be provided at any desired position in the lens arrangement.

In accordance with an advantageous embodiment, beside the first lens manufactured from glass, at least a majority of the remaining lenses, preferably all of the remaining lenses, are manufactured from plastic. Since glass lenses cause a multiple amount of costs in comparison with plastic lenses, this design has proved advantageous with respect to a good cost-benefit ratio. With regard to good chromatic aberration correction, the second lens can also be manufactured from glass, preferably having a relative partial dispersion that is spaced apart from the normal line toward the other side in comparison with the first lens or at least lies on the normal line.

In accordance with a further advantageous embodiment, at least two lenses, preferably the first and second lenses, particularly preferably all the lenses, have at least one aspherical surface. One of the lenses can optionally also only have spherical curvatures. A particularly favorable correction of the aberrations in the objective system is achieved by the interplay of the design of the first lens in accordance with the invention and of the aspheres.

In accordance with a further advantageous embodiment, the Abbe number of the first lens is greater than or equal to 65 and/or the Abbe number of the first lens is smaller than or equal to 85.

The second lens advantageously has an Abbe number between 13 and 33, with a difference between the Abbe number of the first lens and the Abbe number of the second lens amounting to between 35 and 75, preferably between 46 and 75. The first two lenses are accordingly configured in accordance with the principle of a crown flint achromatic objective, with the cementing surface between these lenses preferably being open. Such a configuration contributes to the correction of spherochromatism.

In accordance with a further advantageous embodiment, the overall length L and the total focal length f of the objective satisfy the condition

L/f<1.25.

The overall length can be expressed by the quotient L/f as a relative overall length with respect to the focal length since the focal length is a scaling factor for imaging optical systems.

Alternatively or additionally, the quotient from the overall length L and the diameter of the image circle is smaller than or equal to 0.7. Particularly compact dimensions are hereby defined so that the objective in accordance with the invention is particularly suitable for applications in portable devices, in particular cellular telephones.

The compact dimensions represent a substantial property of the objective in an embodiment in accordance with the invention or in an advantageous embodiment.

The image angle is advantageously greater than or equal to 80° and/or the f-number is smaller than 1.5 (or the lens speed is better than 1:1.5). The half image angle accordingly amounts to ±40° in the corners of a sensor arranged in the image plane. The f-number is the quotient from the focal length f and the diameter of the entrance pupil, i.e. of an aperture D.

In accordance with an advantageous embodiment of the invention, the objective comprises, in an order from an end at the object side to an end at the image side and subsequent to the first lens, at least one second lens having a negative refractive power, a third lens having a positive refractive power, a fourth lens having a negative refractive power, a fifth lens having a positive refractive power, a sixth lens having a positive or a negative refractive power, and a seventh lens having a negative refractive power. An aperture diaphragm can additionally be provided that can preferably be arranged at end of the objective at the object side, i.e. in the optical path in front of the first lens. A planoparallel plate that can preferably be configured as a band-elimination filter for non-visible light (UV light or IR light) can furthermore be arranged at an end of the objective at the image side, i.e. in the optical path behind the seventh lens.

The fourth lens is advantageously configured as a meniscus lens. This has an advantageous effect on the correction of astigmatism.

In accordance with a further advantageous embodiment, the focal length f1 of the first lens and the focal length of the second lens satisfy the condition

f1<|f2|.

The first and second lenses accordingly together have a positive refractive power, which corresponds to the embodiment with an achromatic objective. The focal length of the second lens is typically negative. This focal length condition ensures together with the above-named preferred values for the Abbe numbers of the first and second lenses that the achromasia condition according to which the quotients of the refractive power and the Abbe number of the two lenses should add up to zero is satisfied in a very good approximation. This has the consequence that the first and second lenses thus substantially correct the paraxial longitudinal chromatic aberration due to the dispersive properties of their respective glass materials.

The focal length f2 of the second lens, the focal length f3 of the third lens, and/or the total focal length f of the objective advantageously satisfy at least one of the conditions:

|f2|>f3

1.5<|f2|/f<4.0

1.0<f3/f<3.0

The third lens in particular has a similar refractive power to the first lens. The first to third lenses can also be understood as elements of an apochromatic objective on the basis of these conditions.

The ratio of the focal length f1 of the first lens to the focal length f3 of the third lens advantageously satisfies the condition

0.5<f1/f3<2.0.

In accordance with a further advantageous embodiment, the focal length f1 of the first lens, the focal length f4 of the fourth lens, the focal length f5 of the fifth lens, the focal length f6 of the sixth lens, the focal length f7 of the seventh lens, and/or the total focal length f of the objective satisfy/satisfies at least one of the conditions:

f1<|f4|

f1/f5

f1<|f6|

1.0<f1/f<2.0

−5.0<f4/f<−2.0

3.0<f6/f<7.0

−2.0<f7/f<−0.8

The negative focal length of the seventh lens serves in its property as the last lens of the objective for the image field smoothing and additionally effects a reduction of the overall length by transposing the rear principal point to the front. In addition, a so-called gull-wing shape of the seventh lens preferably provides a correction of the angle of incidence of the principal beams onto a sensor arranged in the image plane.

The common focal length f₁₂ of the first lens and of the second lens and the total focal length f of the objective advantageously satisfy the condition

0.8<f₁₂/f<2.5.

The satisfaction of this condition likewise contributes to a reduced overall length L.

A main beam angle that corresponds to an angle of incidence onto a sensor arranged in the image plane relative to the normal advantageously amounts to a maximum of 37.0° over the total image field. The objective can hereby be used in conjunction with image sensors in which respective microlenses are arranged in front of the individual sensor pixels.

An objective in accordance with one or more of the above-named embodiments is characterized by
compact dimensions;
a high lens speed due to the large aperture ratio;
very good correction of the chromatic aberrations as early as within the first two lenses; and
due to this, improved possibility of correcting further aberrations with the aid of aspheres in the remaining lenses.

Further advantageous embodiments of the invention result from the dependent claims, from the description and from the drawing, with individual features and/or feature groups being able to be combined with one another in a suitable manner—also in a manner differing from the feature combinations explicitly mentioned here.

The invention will be described in the following with reference to embodiments and to the drawings. There are shown:

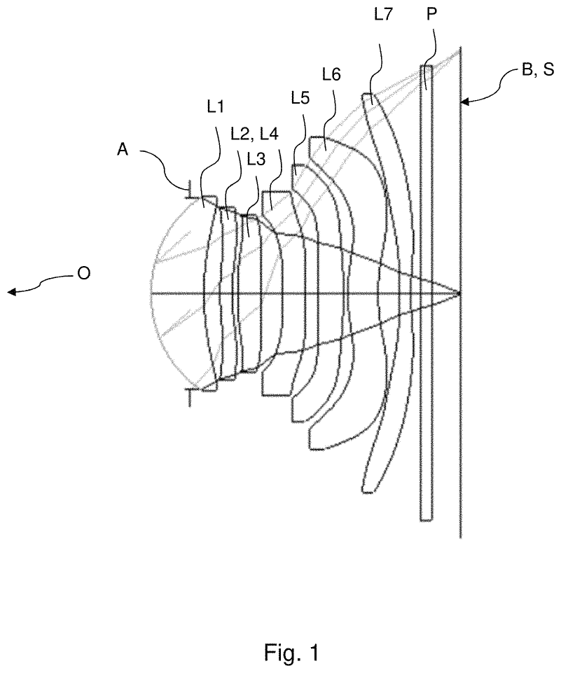

FIG. 1 a lens section of an objective in accordance with a first embodiment of the invention;

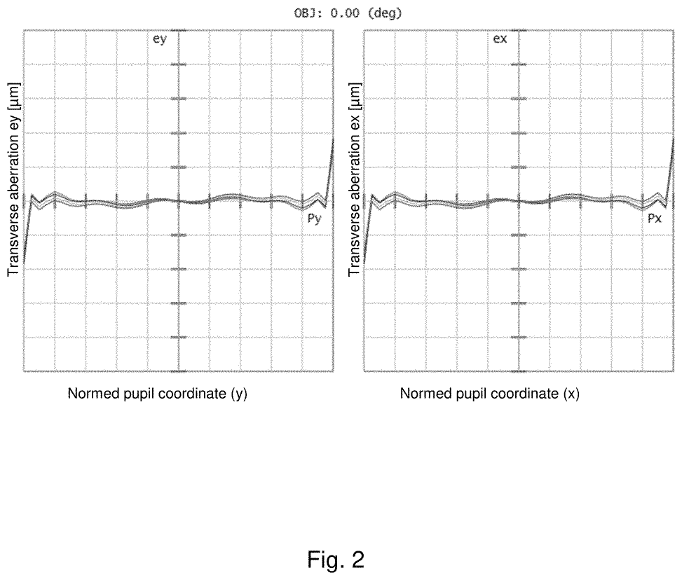

FIG. 2 diagrams of the aberrations of the objective of FIG. 1;

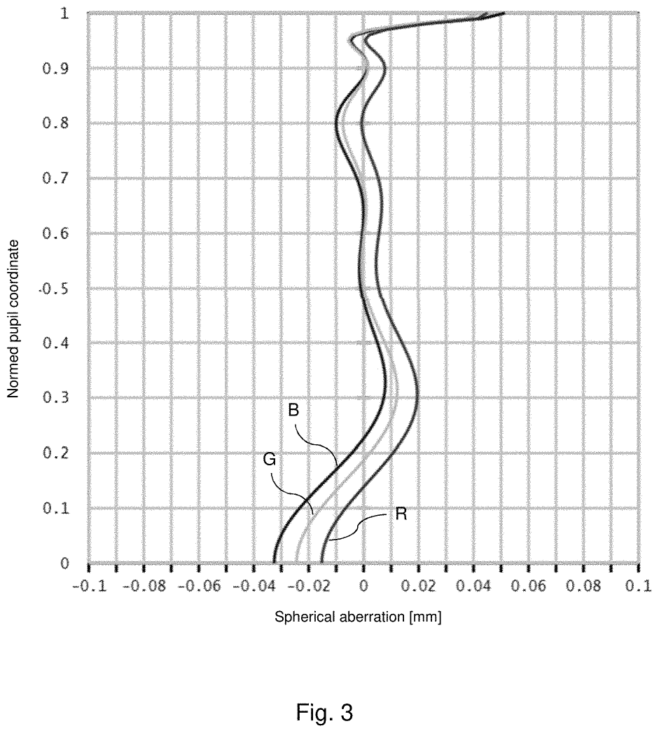

FIG. 3 a diagram of the spherical aberration of the objective of FIG. 1;

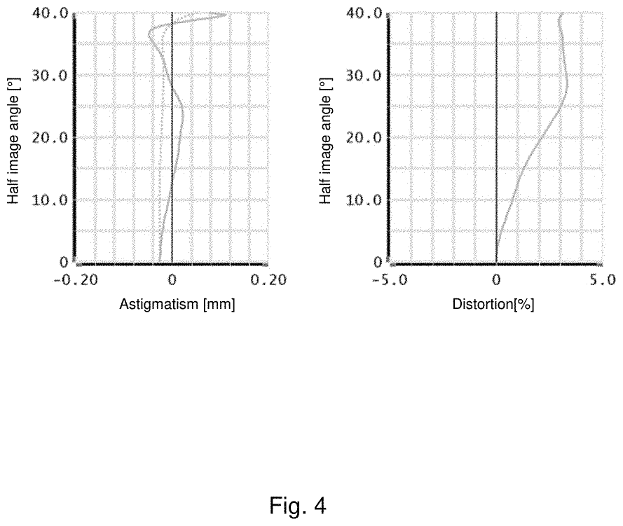

FIG. 4 diagrams of further aberrations of the objective of FIG. 1;

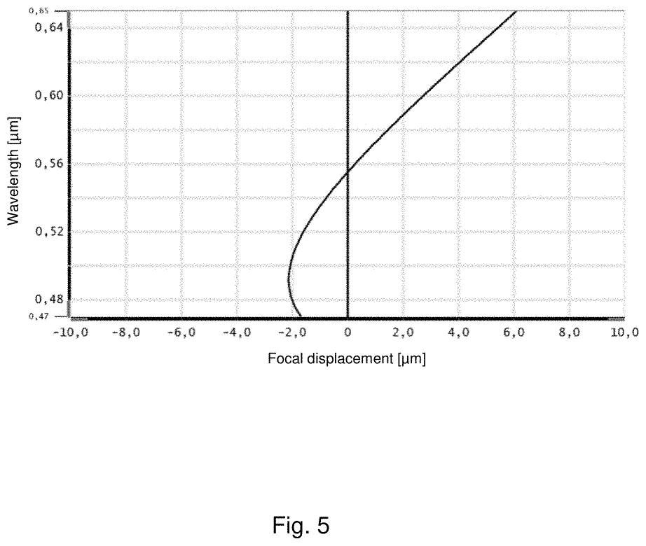

FIG. 5 diagrams of the longitudinal chromatic aberration of the objective of FIG. 1;

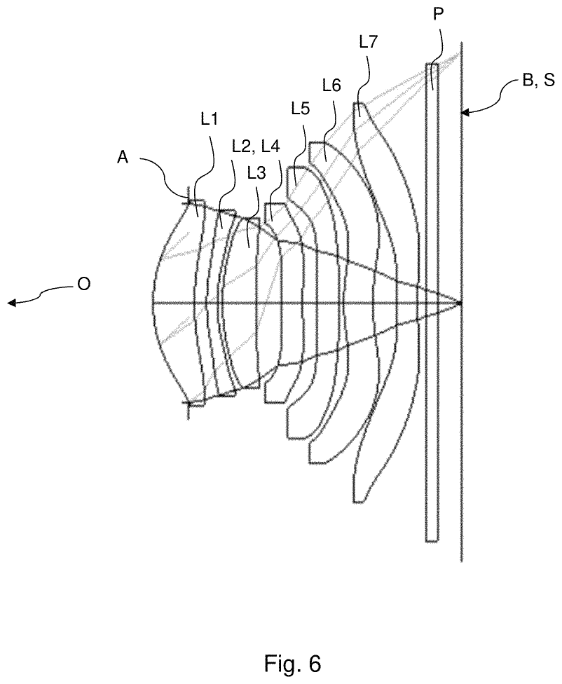

FIG. 6 a lens section of an objective in accordance with a second embodiment of the invention;

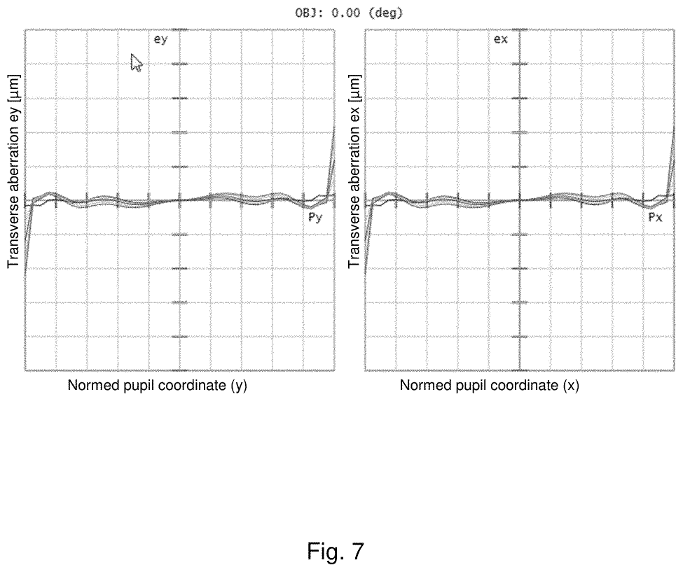

FIG. 7 diagrams of the aberrations of the objective of FIG. 6;

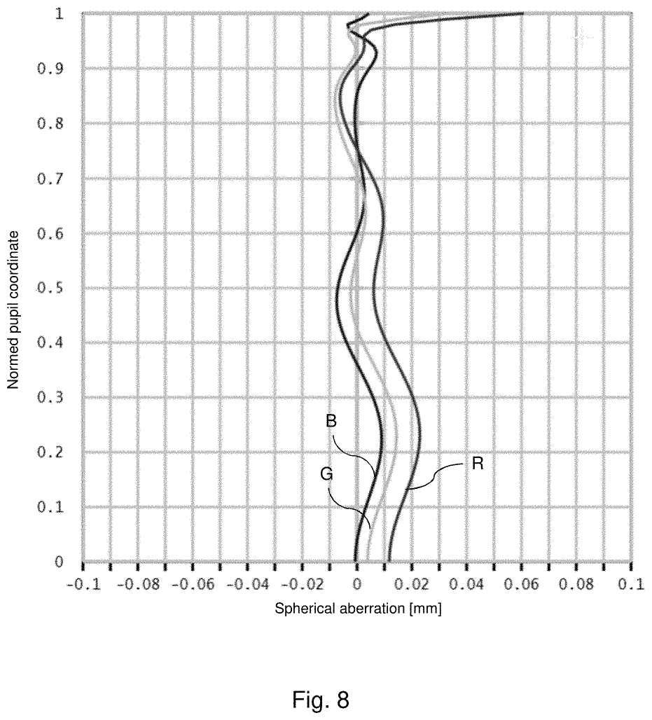

FIG. 8 a diagram of the spherical aberration of the objective of FIG. 6;

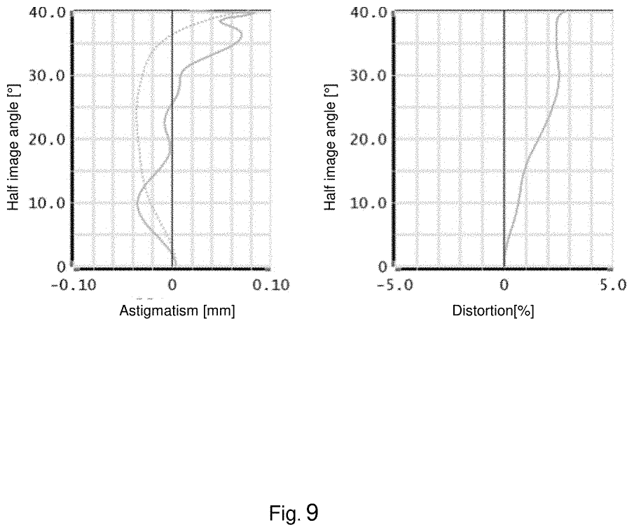

FIG. 9 diagrams of further aberrations of the objective of FIG. 6;

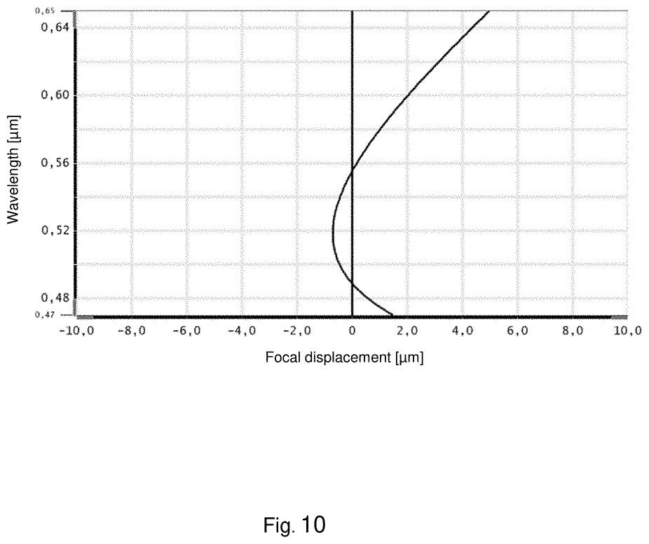

FIG. 10 a diagram of the longitudinal chromatic aberration of the objective of FIG. 6;

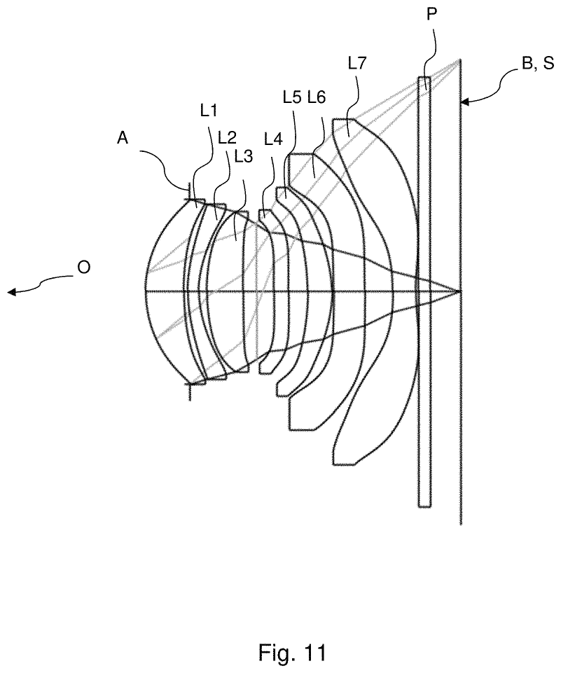

FIG. 11 a lens section of an objective in accordance with a third embodiment of the invention;

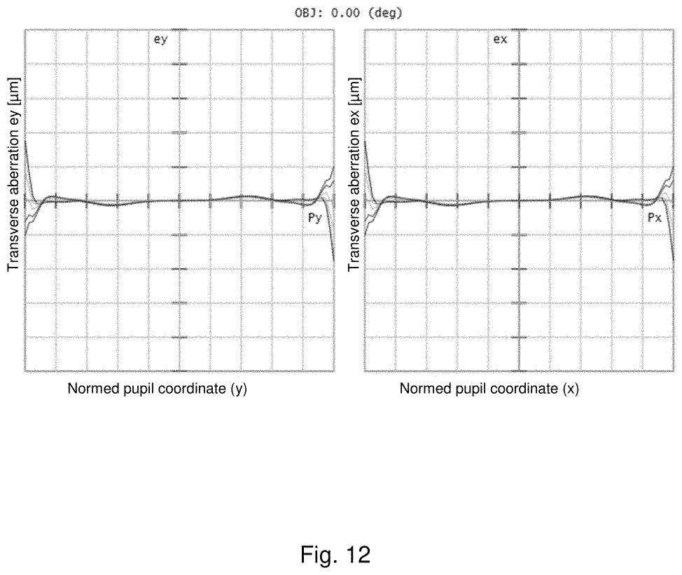

FIG. 12 diagrams of the aberrations of the objective of FIG. 11;

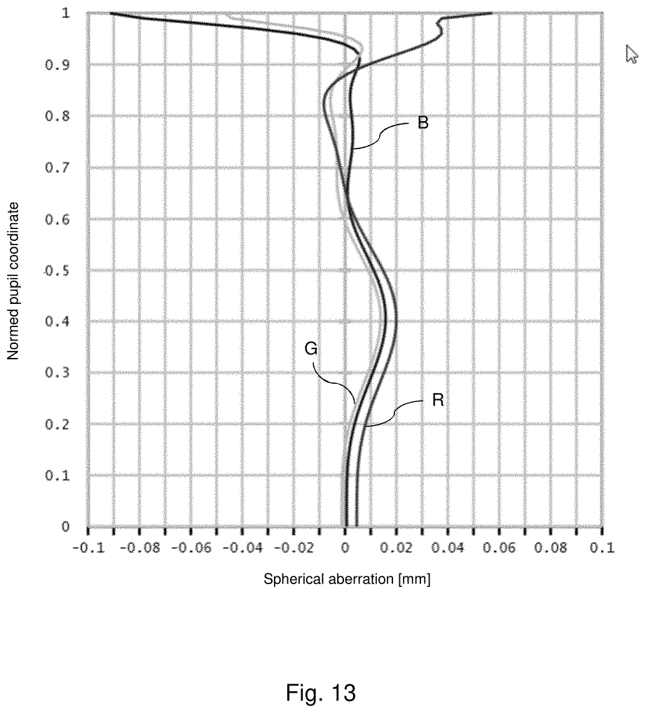

FIG. 13 a diagram of the spherical aberration of the objective of FIG. 11;

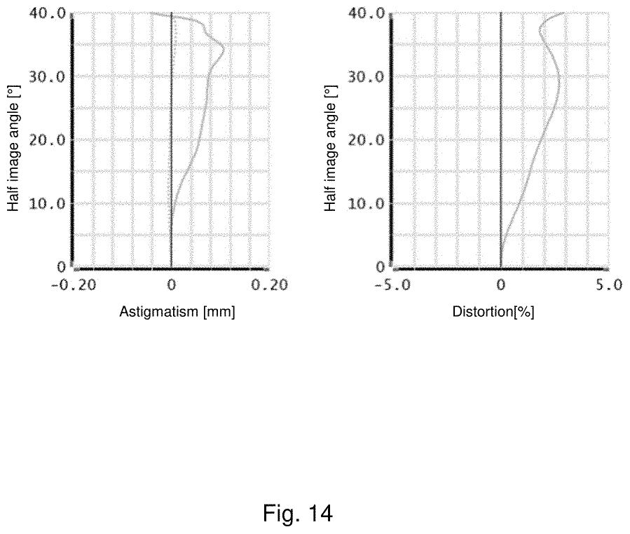

FIG. 14 diagrams of further aberrations of the objective of FIG. 11; and

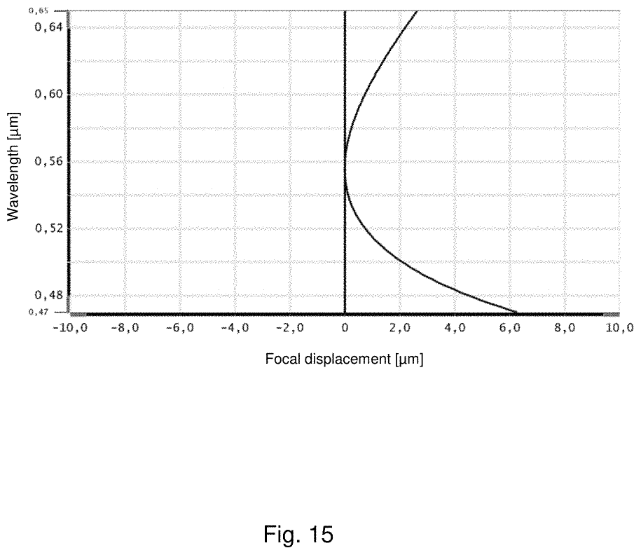

FIG. 15 a diagram of the longitudinal chromatic aberration of the objective of FIG. 11.

FIGS. 1, 6, and 11 show a respective photographic objective having seven refractive lenses L1 to L7 in accordance with three different embodiments. The lenses L1 to L7 are numbered in ascending order in a direction of light propagation of the optical path starting from the object side to the image side. Relative position indications such as “in front of” or “behind” relate to this order.

The objectives each comprise a first lens L1 having a positive refractive power, a second lens L2 having a negative refractive power, a third lens L3 having a positive refractive power, a fourth lens L4 having a negative refractive power, a fifth lens L5 having a positive refractive power, a sixth lens L6 whose refractive power is positive in the first and second embodiments and negative in the third embodiment, and a seventh lens L7 having a negative refractive power. The first lens L1 is surrounded by an aperture diaphragm A that is located approximately on the first surface of the lens L1. A planoparallel plate P is provided as a cover plate behind the seventh lens L7. The planoparallel plate P can be configured as a band-elimination filter for non-visible light (UV light and/or IR light) so that only visible light is transmitted. An image sensor can be arranged with its sensor plane S in the focal plane B.

The first lens L1 and the planoparallel plate are manufactured from glass; the second to seventh lenses L2 to L7 are produced from plastic. The glass used for the first lens L1 has a deviation of the relative partial dispersion ΔP_{g,F} from the normal line of +0.009 for the first and third embodiments and of +0.019 for the second application example.

Detailed design data and optical data for the lens elements of the objective are shown in the following tables. The data relate to the surfaces that designate respective air-to-glass or glass-to-glass transitions and are numbered in ascending order from the end at the object side to the end at the image side. The surface 0 thus designates the object plane 0 at an infinite distance, the surface 1 the effective surface of the aperture diaphragm A, surface 2 the surface at the object side of the first lens L1, surface 3 the surface at the image side of the first lens L1, and so on. The last surface 17 is the surface at the image side of the planoparallel plate P. The surfaces 2 to 15 have an aspherical curvature. The focal length f, the f-number f/#, the overall length L, the image height, and the half image angle are likewise shown in the respective tables.

The following asphere equation applies to a sag z of a respective lens surface in parallel with the optical axis at a point having a height h relative to the optical axis and perpendicular thereto:

$$z ( h ) = \frac{{h}^{2} / r 0}{1 + \sqrt{1 - ( 1 + k ) {( h / r 0 )}^{2}}} + a 4 \cdot {h}^{4} + a 6 \cdot {h}^{6} + … + a 16 \cdot {h}^{16}$$

where r0 is the vertex radius of curvature, k is the conical constant, and A4, A6, . . . , A16 are the aspherical coefficients.

In the following tables, the respective vertex radius of curvature r0 (in millimeters), the conical constant (KK) k, the thickness d or the distance from the next surface along the optical axis, the refractive index of the respective optical material, the Abbe number, and the focal length (in mm) are given for the respective embodiments and the asphere coefficients A4 to A16 are given for the surfaces 2 to 15.

The aberrations of the objectives in accordance with the three embodiments can be specified in the form of a wavefront error W(p, A) that is described by a sum of orthogonal Zernike standard polynomials Pᵢ(p, A) (also written as “Pi”) and of associated coefficients Z; (also written as “Zr”) in the form

$$W ( p , A ) = {\sum }_{i = 1}^{106} {Z}_{i} \cdot {P}_{i} ( p , A )$$

where p is the normed radial distance or the normed pupil coordinate and A is their azimuthal angle. p can adopt values between 0 and 1. Wand Zᵢ are given in coordinates of the wavelength.

Only the coefficients Z4, Z11, Z22, Z37, Z56, Z79, and Z106 are given in the respective tables for the respective rotationally symmetrical Zernike polynomials in the Zernike standard representation. The other Zernike coefficients are 0 since only the axial image point for an object at infinity is looked at. The associated rotationally symmetrical standard Zernike polynomials Pi are defined as follows:

P4=3^{1/2}·(2p²−1)

P11=5^{1/2}·(6p⁴−6p²+1)

P22=7^{1/2}·(20p⁶−30p⁴+12p²−1)

P37=9^{1/2}·(70p⁸−140p⁶+90p⁴−20p²+1)

P56=11^{1/2}·(252p¹⁰−630p⁸+560p⁶−210p⁴+30p²−1)

P79=13^{1/2}·(924p¹²−2772p¹⁰+3150p⁸−1680p⁶−420p⁴−42p²+1)

P106=15^{1/2}·(3432p¹⁴−12012p¹²+16632p¹⁰−11550p⁸+4200p⁶−756p⁴+56p²−1)

First embodiment:

| Focal length f | 4.65 mm |
|---|---|
| f-number f/# | 1.45 |
| Overall length L | 5.60 mm |
| Image height | 4.10 mm |
| Half image angle | 40.0° |

| | | | | | Refrac- | Abbe | |
|---|---|---|---|---|---|---|---|
| Sur- | Ele- | Radius | | Thick- | tive | num- | Focal |
| face | ment | r0 | KK k | ness d | index | ber | length |
| 0 | Object | Plano | | ∞ | | | |
| 1 | Aper- | Plano | | −0.705 | | | |
| | ture | | | | | | |
| 2 | Lens 1 | 1.872 | −0.27 | 0.954 | 1.5378 | 74.7 | 5.69 |
| 3 | | 3.944 | 0.00 | 0.292 | | | |
| 4 | Lens 2 | 3.550 | 0.00 | 0.216 | 1.6707 | 19.2 | −17.38 |
| 5 | | 2.661 | 0.00 | 0.098 | | | |
| 6 | Lens 3 | 4.153 | 0.04 | 0.425 | 1.5449 | 55.9 | 7.58 |
| 7 | | −1878.147 | 0.00 | 0.396 | | | |
| 8 | Lens 4 | −13.281 | 0.00 | 0.402 | 1.6707 | 19.2 | −13.50 |
| 9 | | 29.656 | −522.90 | 0.235 | | | |
| 10 | Lens 5 | −7.762 | 0.00 | 0.460 | 1.6613 | 20.4 | 16.36 |
| 11 | | −4.644 | −1.86 | 0.072 | | | |
| 12 | Lens 6 | 2.304 | 0.00 | 0.548 | 1.5449 | 55.9 | 21.71 |
| 13 | | 2.619 | 0.00 | 0.385 | | | |
| 14 | Lens 7 | −45.558 | 0.00 | 0.209 | 1.6150 | 25.9 | −5.54 |
| 15 | | 3.719 | 0.00 | 0.169 | | | |
| 16 | Cover | Plano | | 0.210 | 1.5168 | 64.2 | — |
| | lens | | | | | | |
| 17 | | | | 0.521 | | | |

| Surface | a4 | a6 | a8 | a10 |
|---|---|---|---|---|
| 2 | −1.327E−03 | 1.407E−02 | −1.513E−02 | 1.011E−02 |
| 3 | −1.331E−02 | −2.220E−04 | 7.955E−03 | −9.670E−03 |
| 4 | −1.270E−01 | 3.874E−02 | −2.893E−02 | 2.785E−02 |
| 5 | −1.383E−01 | 7.376E−02 | −1.355E−01 | 1.348E−01 |
| 6 | −2.025E−02 | 6.622E−02 | −1.808E−01 | 1.647E−01 |
| 7 | −1.047E−02 | 6.526E−03 | 1.553E−02 | −5.700E−02 |
| 8 | −1.045E−01 | −7.732E−03 | 3.767E−02 | −1.053E−02 |
| 9 | −4.468E−02 | −8.883E−02 | 1.095E−01 | −7.834E−02 |
| 10 | 1.622E−01 | −1.765E−01 | 1.039E−01 | −5.462E−02 |
| 11 | 5.854E−02 | 9.342E−03 | −4.248E−02 | 2.557E−02 |
| 12 | −1.432E−01 | 3.649E−02 | −3.703E−02 | 2.475E−02 |
| 13 | −4.999E−02 | −2.554E−02 | 1.504E−02 | −3.541E−03 |
| 14 | −1.119E−01 | 6.644E−02 | −1.892E−02 | 2.932E−03 |
| 15 | −1.485E−01 | 6.409E−02 | −1.652E−02 | 2.509E−03 |

| Surface | a12 | a14 | a16 |
|---|---|---|---|
| 2 | −3.299E−03 | 4.528E−04 | 0 |
| 3 | 4.459E−03 | −7.283E−04 | 0 |
| 4 | −1.230E−02 | 2.440E−03 | −1.838E−04 |
| 5 | −5.826E−02 | 9.204E−03 | 7.971E−05 |
| 6 | −7.464E−02 | 1.462E−02 | −5.364E−04 |
| 7 | 4.248E−02 | −1.408E−02 | 1.881E−03 |
| 8 | −3.480E−02 | 3.302E−02 | −9.177E−03 |
| 9 | 3.731E−02 | −9.475E−03 | 9.436E−04 |
| 10 | 2.099E−02 | −4.803E−03 | 4.749E−04 |
| 11 | −7.770E−03 | 1.222E−03 | −7.837E−05 |
| 12 | −8.065E−03 | 1.249E−03 | −7.469E−05 |
| 13 | 3.754E−04 | −1.351E−05 | −3.710E−07 |
| 14 | −2.542E−04 | 1.164E−05 | −2.198E−07 |
| 15 | −2.224E−04 | 1.064E−05 | −2.123E−07 |

Zernike coefficients

| | |
|---|---|
| Z4 | 0.02259354 |
| Z11 | 0.04163554 |
| Z22 | −0.03177698 |
| Z37 | −0.01030995 |
| Z56 | −0.00177185 |
| Z79 | −0.00181112 |
| Z106 | 0.00405671 |

Second embodiment

| Focal length f | 4.75 mm |
|---|---|
| f-number f/# | 1.45 |
| Overall length L | 5.60 mm |
| Image height | 4.12 mm |
| Half image angle | 40.0° |

| | | | | | Refrac- | Abbe | |
|---|---|---|---|---|---|---|---|
| Sur- | Ele- | Radius | | Thick- | tive | num- | Focal |
| face | ment | r0 | KK k | ness d | index | ber | length |
| 0 | Object | Plano | | ∞ | | | |
| 1 | Aper- | Plano | | −0.640 | | | |
| | ture | | | | | | |
| 2 | Lens 1 | 2.037 | −0.21 | 0.751 | 1.5927 | 67.0 | 6.45 |
| 3 | | 3.759 | 3.79 | 0.223 | | | |
| 4 | Lens 2 | 2.657 | −0.03 | 0.190 | 1.6707 | 19.2 | −12.71 |
| 5 | | 1.971 | 0.00 | 0.095 | | | |
| 6 | Lens 3 | 2.718 | −1.96 | 0.604 | 1.5449 | 55.9 | 6.34 |
| 7 | | 11.572 | 0.00 | 0.474 | | | |
| 8 | Lens 4 | 30.167 | 0.00 | 0.379 | 1.6707 | 19.2 | −26.37 |
| 9 | | 11.157 | −850.44 | 0.265 | | | |
| 10 | Lens 5 | −8.427 | 0.00 | 0.403 | 1.6613 | 20.4 | 309.4 |
| 11 | | −8.257 | −223.25 | 0.076 | | | |
| 12 | Lens 6 | 2.336 | 0.00 | 0.531 | 1.5449 | 55.9 | 17.63 |
| 13 | | 2.835 | 0.11 | 0.437 | | | |
| 14 | Lens 7 | 41.612 | 0.00 | 0.367 | 1.6150 | 25.9 | −6.03 |
| 15 | | 3.415 | −0.68 | 0.169 | | | |
| 16 | Cover | Plano | 0.00 | 0.210 | 1.5168 | 64.2 | — |
| | lens | | | | | | |
| 17 | | | 0.00 | 0.425 | | | |

| Surface | a4 | a6 | a8 | a10 |
|---|---|---|---|---|
| 2 | −3.79E−04 | 4.31E−03 | −7.24E−03 | 3.16E−03 |
| 3 | −1.59E−02 | −4.31E−03 | −1.08E−02 | 4.10E−03 |
| 4 | −1.04E−01 | 8.20E−02 | −9.84E−02 | 6.40E−02 |
| 5 | −1.50E−01 | 1.37E−01 | −1.58E−01 | 9.96E−02 |
| 6 | −4.64E−02 | 9.97E−02 | −1.43E−01 | 1.22E−01 |
| 7 | −8.31E−03 | −5.13E−04 | 2.82E−02 | −5.52E−02 |
| 8 | −5.77E−02 | −7.72E−02 | 1.18E−01 | −9.09E−02 |
| 9 | 1.50E−02 | −1.26E−01 | 1.05E−01 | −5.33E−02 |
| 10 | 1.24E−01 | −1.39E−01 | 9.35E−02 | −6.19E−02 |
| 11 | −2.83E−02 | 4.63E−02 | −4.91E−02 | 2.57E−02 |
| 12 | −1.72E−01 | 6.56E−02 | −5.31E−02 | 2.87E−02 |
| 13 | −8.13E−02 | −7.96E−04 | 2.34E−03 | 1.86E−04 |
| 14 | −1.73E−01 | 7.93E−02 | −1.94E−02 | 2.84E−03 |
| 15 | −1.64E−01 | 6.41E−02 | −1.56E−02 | 2.36E−03 |

| Surface | a12 | a14 | a16 |
|---|---|---|---|
| 2 | −3.78E−04 | −3.69E−04 | 8.90E−05 |
| 3 | −1.53E−05 | −1.80E−04 | 0.00E+00 |
| 4 | −1.58E−02 | 5.85E−05 | 3.31E−04 |
| 5 | −2.34E−02 | −7.20E−04 | 6.05E−04 |
| 6 | −6.29E−02 | 1.90E−02 | −2.37E−03 |
| 7 | 5.13E−02 | −2.54E−02 | 5.59E−03 |
| 8 | 1.72E−02 | 1.10E−02 | −4.67E−03 |
| 9 | 1.21E−02 | 3.26E−04 | −3.32E−04 |
| 10 | 2.76E−02 | −7.13E−03 | 7.98E−04 |
| 11 | −7.37E−03 | 1.10E−03 | −6.75E−05 |
| 12 | −8.12E−03 | 1.15E−03 | −6.56E−05 |
| 13 | −2.40E−04 | 4.22E−05 | −2.41E−06 |
| 14 | −2.49E−04 | 1.20E−05 | −2.48E−07 |
| 15 | −2.21E−04 | 1.18E−05 | −2.69E−07 |

Zernike coefficients

| | |
|---|---|
| Z4 | 0.04517135 |
| Z11 | 0.05512979 |
| Z22 | −0.01687755 |
| Z37 | −0.00821987 |
| Z56 | −0.01754453 |
| Z79 | 0.00946136 |
| Z106 | 0.00708409 |

Third embodiment

| Focal length f | 4.78 mm |
|---|---|
| f-number f/# | 1.45 |
| Overall length L | 5.60 mm |
| Image height | 4.13 mm |
| Half image angle | 40.0° |

| | | | | | Refrac- | Abbe | |
|---|---|---|---|---|---|---|---|
| Sur- | Ele- | Radius | | Thick- | tive | num- | Focal |
| face | ment | r0 | KK k | ness d | index | ber | length |
| 0 | Object | Plano | | ∞ | | | |
| 1 | Aper- | Plano | | −0.640 | | | |
| | ture | | | | | | |
| 2 | Lens 1 | 2.054 | 0.000 | 0.680 | 1.5927 | 67.0 | 5.50 |
| 3 | | 4.854 | −0.003 | 0.069 | | | |
| 4 | Lens 2 | 2.457 | 0.000 | 0.197 | 1.6707 | 19.2 | −9.68 |
| 5 | | 1.729 | 0.000 | 0.144 | | | |
| 6 | Lens 3 | 3.504 | 0.002 | 0.645 | 1.5449 | 55.9 | 6.37 |
| 7 | | 41.031 | 4.722 | 0.242 | | | |
| 8 | Lens 4 | 21.367 | 0.334 | 0.565 | 1.6355 | 23.97 | −949.5 |
| 9 | | 20.544 | 0.534 | 0.340 | | | |
| 10 | Lens 5 | −4.671 | −6.947 | 0.433 | 1.5449 | 55.9 | 5.98 |
| 11 | | −1.986 | −0.605 | 0.031 | | | |
| 12 | Lens 6 | −7.947 | 16.210 | 0.553 | 1.6355 | 23.97 | −19.57 |
| 13 | | −22.322 | −37.502 | 0.497 | | | |
| 14 | Lens 7 | −4.300 | −4.698 | 0.407 | 1.5094 | 56.47 | −3.86 |
| 15 | | 3.764 | −0.072 | 0.050 | | | |
| 16 | Cover | Plano | 0.000 | 0.210 | 1.5168 | 64.2 | — |
| | lens | | | | | | |
| 17 | | | 0.000 | 0.540 | | | |

| Surface | a4 | a6 | a8 | a10 |
|---|---|---|---|---|
| 2 | 6.80E−04 | −1.05E−03 | 4.78E−03 | −5.43E−03 |
| 3 | 1.83E−02 | −3.68E−03 | 2.67E−03 | 1.06E−03 |
| 4 | −6.77E−02 | 8.27E−03 | 2.50E−02 | −2.14E−02 |
| 5 | −9.56E−02 | 2.11E−02 | 8.88E−03 | −8.11E−04 |
| 6 | 1.87E−02 | −2.82E−02 | 4.53E−02 | −1.64E−02 |
| 7 | 1.83E−02 | −6.74E−02 | 1.35E−01 | −1.33E−01 |
| 8 | −7.36E−02 | 2.22E−02 | −6.15E−02 | 4.26E−02 |
| 9 | −8.03E−02 | 8.67E−02 | −1.60E−01 | 1.27E−01 |
| 10 | −8.72E−02 | 2.11E−01 | −2.72E−01 | 1.83E−01 |
| 11 | 1.07E−01 | −6.24E−02 | −4.40E−02 | 8.31E−02 |
| 12 | 1.59E−01 | −2.37E−01 | 1.46E−01 | −5.17E−02 |
| 13 | 5.13E−02 | −8.21E−02 | 4.07E−02 | −1.11E−02 |
| 14 | −8.77E−02 | −6.89E−03 | 2.33E−02 | −8.03E−03 |
| 15 | −1.12E−01 | 2.80E−02 | −2.46E−03 | −4.95E−04 |

| Surface | a12 | a14 | a16 |
|---|---|---|---|
| 2 | 2.57E−03 | −4.60E−04 | 0.00E+00 |
| 3 | −5.51E−04 | −1.97E−05 | 0.00E+00 |
| 4 | 6.96E−03 | −8.41E−04 | 0.00E+00 |
| 5 | −5.07E−03 | 1.16E−03 | 0.00E+00 |
| 6 | 1.32E−03 | 4.27E−04 | 0.00E+00 |
| 7 | 6.83E−02 | −1.30E−02 | 0.00E+00 |
| 8 | −1.57E−02 | 1.58E−03 | −1.13E−04 |
| 9 | −5.15E−02 | 7.07E−03 | 6.26E−04 |
| 10 | −6.34E−02 | 8.37E−03 | 3.31E−05 |
| 11 | −4.29E−02 | 9.29E−03 | −7.31E−04 |
| 12 | 1.06E−02 | −1.39E−03 | 1.17E−04 |
| 13 | 1.69E−03 | −1.32E−04 | 3.98E−06 |
| 14 | 1.24E−03 | −9.33E−05 | 2.78E−06 |
| 15 | 1.50E−04 | −1.47E−05 | 5.19E−07 |

Zernike coefficients

| | |
|---|---|
| Z4 | −0.001123 |
| Z11 | 0.060063 |
| Z22 | −0.067759 |
| Z37 | −0.026434 |
| Z56 | 0.018399 |
| Z79 | 0.004181 |
| Z106 | 0.013461 |

Different aberrations will be specified for the three embodiments in the following.

The transverse aberrations ex, ey (in μm) for the normed pupil coordinates x and y directions for the axial image point are reproduced in FIG. 2 for the first embodiment, in FIG. 7 for the second embodiment, and in FIG. 12 for the third embodiment. The end of scale values of the transverse aberrations ex, ey each amount to +/−50 μm.

The spherical longitudinal aberration (in mm) in dependence on the normed pupil coordinate is reproduced in FIG. 3 for the first embodiment, in FIG. 8 for the second embodiment, and in FIG. 13 for the third embodiment, in each case for the colors red (R), blue (B), and green (G).

The astigmatism (in mm) in dependence on the half image angle (called +Y, in degrees) and the distortion (in percent) in dependence on the half image angle (in degrees) are reproduced in FIG. 4 for the first embodiment, in FIG. 9 for the second embodiment, and in FIG. 14 for the third embodiment.

The longitudinal chromatic aberration of a focal length displacement (in μm) in dependence on the wavelength (in μm) is reproduced in FIG. 5 for the first embodiment, in FIG. 10 for the second embodiment, and in FIG. 15 for the third embodiment.

### REFERENCE NUMERAL LIST

A aperture diaphragm
B image plane
O object plane
P planoparallel plate
S sensor plane
L1-L7 first to seventh lenses

1. A photographic objective comprising at least six lenses and at most eight lenses, wherein the first lens viewed from the object side is manufactured from glass and has a positive refractive power, an Abbe number of more than or equal to 55 and a deviation of the relative partial dispersion from the normal line ΔP_{g,F} between 0.008 and 0.035.

2. The objective in accordance with claim 1,
wherein the objective comprises at least seven lenses.

3. The objective in accordance with claim 1,
wherein, beside the first lens manufactured from glass, at least a majority of the remaining lenses are manufactured from plastic.

4. The objective in accordance with claim 1,
wherein at least two lenses have at least one respective aspherical surface.

5. The objective in accordance with claim 1,
wherein the Abbe number of the first lens is greater than or equal to 65.

6. The objective in accordance with claim 1,
wherein the Abbe number of the first lens is smaller than or equal to 85.

7. The objective in accordance with claim 1,
wherein the second lens has an Abbe number between 13 and 33.

8. The objective in accordance with claim 1,
wherein the overall length L and the total focal length f of the objective satisfy the condition L/f<1.25.

9. The objective in accordance with claim 1,
wherein the quotient from the overall length L and the diameter of the image circle is smaller than or equal to 0.7.

10. The objective in accordance with claim 1,
wherein the image angle is greater than or equal to 80°.

11. The objective in accordance with claim 1,
wherein the f-number is smaller than 1.5.

12. The objective in accordance with claim 1,
wherein the objective comprises, in an order from an end at the object side to an end at the image side and subsequent to the first lens, at least one second lens having a negative refractive power, a third lens having a positive refractive power, a fourth lens having a negative refractive power, a fifth lens having a positive refractive power, a sixth lens having a positive or a negative refractive power, and a seventh lens having a negative refractive power.

13. The objective in accordance with claim 1,
wherein at least the fourth lens is configured as a meniscus lens.

14. The objective in accordance with claim 1,
wherein the focal length of the first lens and the focal length of the second lens satisfy the condition
f1<|f2|.

15. The objective in accordance with claim 1,
wherein the focal length f2 of the second lens, the focal length f3 of the third lens, and/or the total focal length f of the objective satisfies/satisfy at least one of the conditions

|f2|>f3
1.5<|f2|/f<4.0
1.0<f3/f<3.0.

16. The objective in accordance with claim 1,
wherein the focal length f1 of the first lens, the focal length f4 of the fourth lens, the focal length f5 of the fifth lens, the focal length f6 of the sixth lens, the focal length f7 of the seventh lens, and/or the total focal length f of the objective satisfy/satisfies at least one of the conditions
f1<|f4|

f1/f5
f1<|f6|

1.0<f1/f<2.0
−5.0<f4/f<−2.0
3.0<f6/f<7.0
−2.0<f7/f<−0.8

17. The objective in accordance with claim 1,
wherein the common focal length f₁₂ of the first lens and of the second lens and the total focal length f of the objective satisfy the condition
0.8<f₁₂/f<2.5.

18. The objective in accordance with claim 1,
wherein a main beam angle that corresponds to an angle of incidence onto a sensor arranged in the image plane relative to the normal amounts to a maximum of 37.0° over the total image field.
